(19) United States
(12) Patent Application Publication
(10) Pub. No.: US 2020/0278060 A1
(43) Pub. Date: Sep. 3, 2020

(54) HYDRAULIC HOSE CLAMP

(71) Applicant: Jeffrey Alan Boggio, Bridgeport, WV (US)

(72) Inventor: Jeffrey Alan Boggio, Bridgeport, WV (US)

(21) Appl. No.: 16/288,333

(22) Filed: Feb. 28, 2019

(51) Int. Cl. F16L 19/06

(52) U.S. Cl. CPC F16L 19/06

(57) ABSTRACT

A hydraulic hose clamp includes an elongated body having a first end and a second end. A first U-shaped plate is pivotably coupled to the first end and extends downwards from the elongated body. A handle is fixedly coupled to the first U-shaped plate. A second U-shaped plate is coupled to the second end and extends downwards from the elongated body. Urging the handle forwards pivots the first U-shaped plate inwards along a horizontal axis perpendicular to the elongated body.

### BACKGROUND OF THE INVENTION

The present invention relates to hydraulic hoses and, more particularly, to a device for connecting hydraulic hose fittings.

Hydraulic hoses are used for hydraulics. Hydraulic hoses are graded by pressure, temperature, and fluid compatibility. Hoses are used to provide flexibility for machine operation or maintenance. The hose is built up with rubber and steel layers. A rubber interior is surrounded by multiple layers of woven wire and rubber. The exterior is designed for abrasion resistance. The weakest part of the high-pressure hose is the connection of the hose to the fitting.

To connect fittings of a hydraulic hose together, the current method is to use two straps to pull the fittings together or a hammer and blocks to pound the fittings together. Current methods of connection make it difficult to get the staple lock fittings to engage.

As can be seen, there is a need for an improved device for connecting hydraulic hose fittings.

### SUMMARY OF THE INVENTION

In one aspect of the present invention, a hydraulic hose clamp comprises: an elongated body comprising a first end and a second end; a first bracket comprising a top portion and a bottom portion, wherein the top portion is pivotably coupled to the first end of the elongated body; a handle fixedly coupled to the top portion of the first bracket and extending upwards from the elongated body; a first U-shaped plate fixedly coupled to the bottom portion of the first bracket and extending downwards from the elongated body; a second bracket comprising a top portion and a bottom portion, wherein the top portion is fixedly coupled to the second end of the elongated body; and a second U-shaped plate fixedly coupled to the bottom portion of the second bracket and extending downwards from the elongated body.

In another aspect of the present invention, a method of locking a first pipe end to a second pipe end together comprises: providing a hydraulic hose clamp comprising: an elongated body comprising a first end and a second end; a first U-shaped plate pivotable coupled to the first end and extending downwards from the elongated body; a handle fixedly coupled to the first U-shaped plate; a second U-shaped plate coupled to the second end and extending downwards from the elongated body; placing the first U-shaped plate around the first pipe and the second U-shaped plate around the second pipe; and applying pressure to the handle, thereby pivoting the first U-shaped plate inwards and pushing the first pipe end towards the second pipe end.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a perspective view of an embodiment of the present invention, shown in use;

FIG. 3 is a perspective view of an embodiment of the present invention, shown in use;

FIG. 4 is an exploded view of an embodiment of the present invention; and

FIG. 5 is a side view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

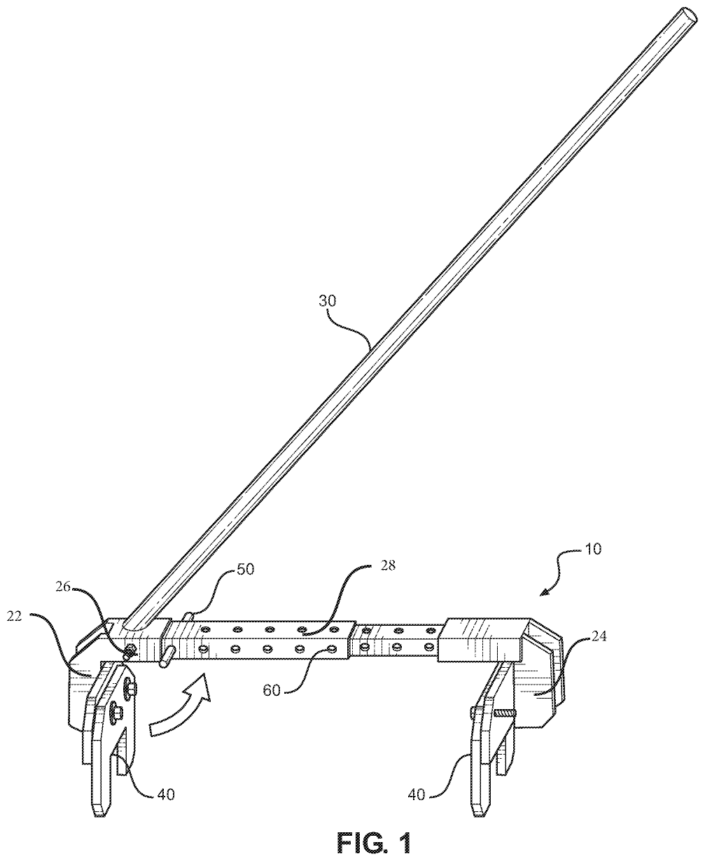

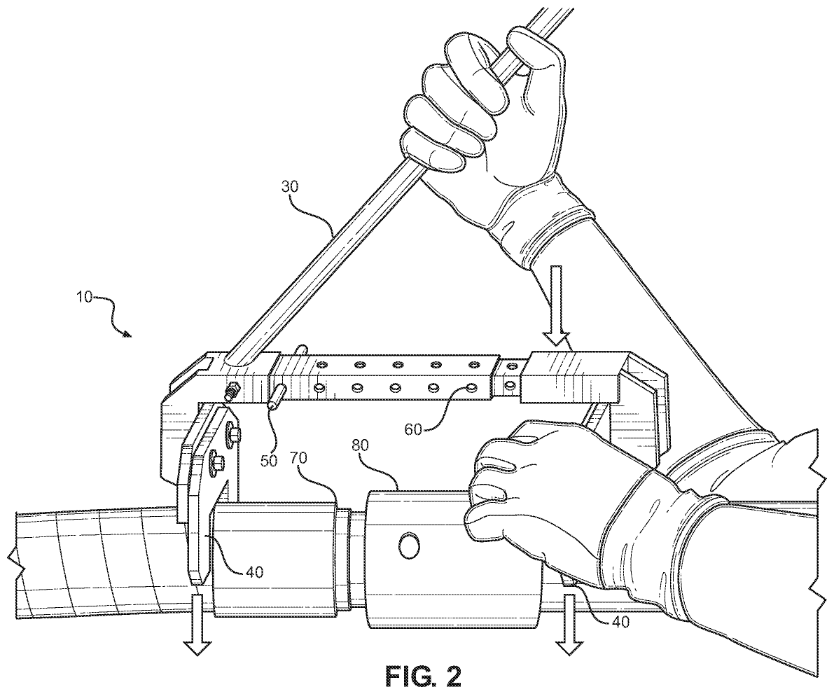

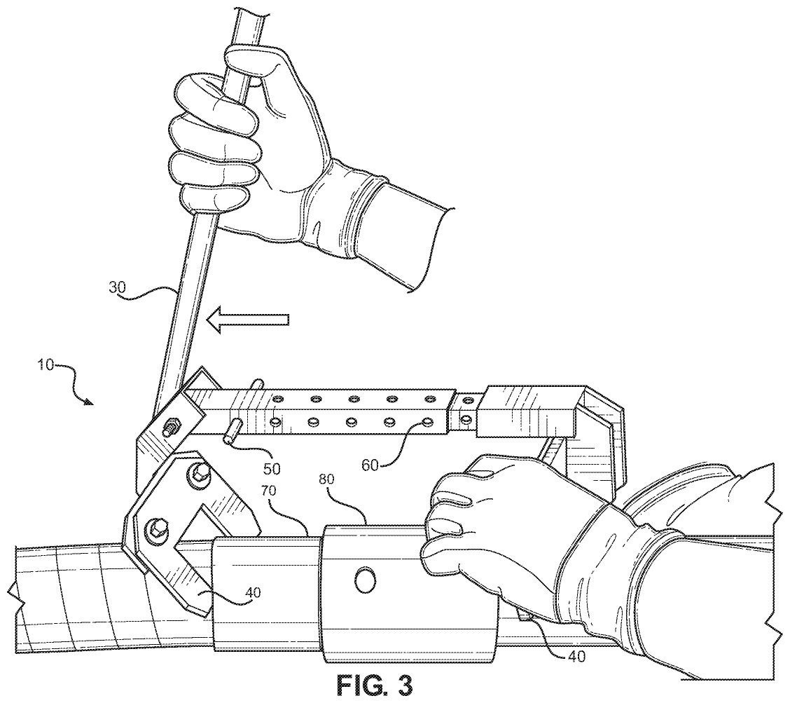

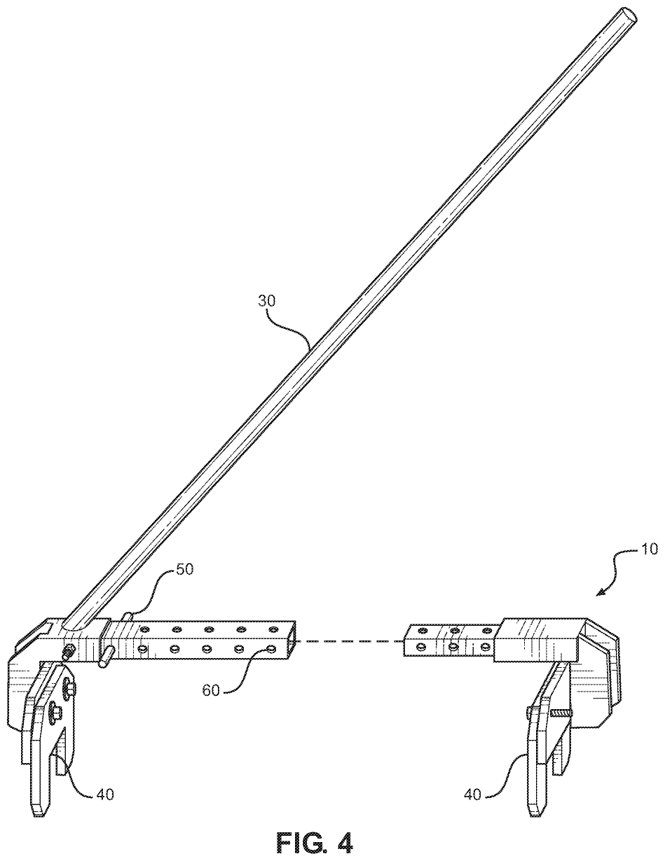

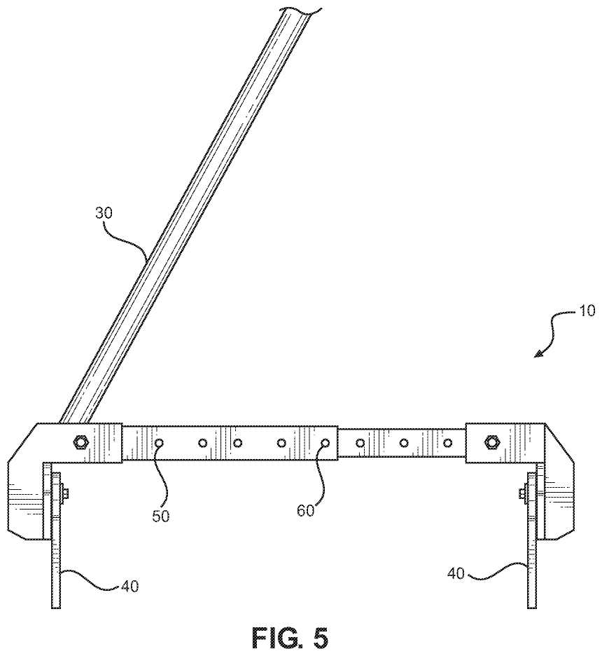

Referring to FIGS. 1 through 5, the present invention includes a hydraulic hose clamp 10. The hydraulic host clamp 10 includes an elongated body 28 having a first end and a second end. A first U-shaped plate 40 is pivotably coupled to the first end and extends downwards from the elongated body 28. A handle 30 is fixedly coupled to the first U-shaped plate 40. A second U-shaped plate 40 is coupled to the second end and extends downwards from the elongated body 28. Urging the handle 30 forwards pivots the first U-shaped plate 40 inwards along a horizontal axis perpendicular to the elongated body 28.

The first U-shaped plate 40 may be pivotably coupled to the elongated body 28 by a first bracket 22. The first bracket 22 includes a top portion and a bottom portion. The top portion is pivotably coupled to the first end of the elongated body 28 by a pivot bolt 26. The handle 30 is fixedly coupled to the top portion of the first bracket 22 and extends upwards from the elongated body 28. The second U-shaped plate 40 is fixedly coupled to the elongated body by a second bracket 24. The second bracket 24 includes a top portion and a bottom portion. The top portion is fixedly coupled to the second end of the elongated body 28. The second U-shaped plate 40 is fixedly coupled to the bottom portion of the second bracket 24 and extends downwards from the elongated body 28. The first U-shaped plate 40 is aligned with, parallel to, and facing the second U-shaped plate 40.

In certain embodiments, a length of the elongated body 28 is adjustable. In such embodiments, the elongated body 28 includes telescoping tubes. One of the telescoping tubes includes at least one opening 60, and the other of the telescoping tubes includes a plurality of openings 60. A lock pin 50 fits within aligning openings of the telescoping tubes, locking the telescoping tubes together. To adjust the length, the lock pin 50 is removed, and the telescoping tubes slide either away from one another to extend the length of the elongated body 28 or towards one another to shorten the length of the elongated body 28. The lock pin 50 is then inserted into aligned openings 60 to lock the tubes at the desired length.

A method of locking a first pipe end 70 to a second pipe end 80 may include the following steps. Provide the hydraulic hose clamp 10 described above. Place the first U-shaped plate 40 around the first pipe and the second U-shaped plate 40 around the second pipe. Adjust the length of the body 28 until the first and second U-shaped plates 40 are tight to the back of the fittings. Apply pressure to the handle 30 by pushing the handle 30 forwards and away from the second U-shaped plate 40, thereby pivoting the first U-shaped plate 40 inwards and pushing the first pipe end 70 into the second pipe end 80, locking the fittings together. The present invention reduces time and effort needed to make the connection of the high-pressure hose fittings. The present invention also reduces the amount of damage that can be done to the fitting thus preventing an unsafe connection.

It should be understood, of course, that the foregoing relates to exemplary embodiments of the invention and that modifications may be made without departing from the spirit and scope of the invention as set forth in the following claims.

What is claimed is:

1. A hydraulic hose clamp comprising:
an elongated body comprising a first end and a second end;
a first bracket comprising a top portion and a bottom portion, wherein the top portion is pivotably coupled to the first end of the elongated body;
a handle fixedly coupled to the top portion of the first bracket and extending upwards from the elongated body;
a first U-shaped plate fixedly coupled to the bottom portion of the first bracket and extending downwards from the elongated body;
a second bracket comprising a top portion and a bottom portion, wherein the top portion is fixedly coupled to the second end of the elongated body; and
a second U-shaped plate fixedly coupled to the bottom portion of the second bracket and extending downwards from the elongated body.

2. The hydraulic hose clamp of claim 1, wherein the first bracket pivots along a horizontal axis perpendicular to the elongated body.

3. The hydraulic hose clamp of claim 1, wherein the first U-shaped plate is aligned with the second U-shaped plate.

4. The hydraulic host clamp of claim 1, wherein a length of the elongated body is adjustable.

5. The hydraulic hose clamp of claim 4, wherein the elongated body comprises telescoping tubes, wherein one of the telescoping tubes comprises at least one opening, and the other of the telescoping tubes comprises a plurality of openings, wherein a lock pin fits within aligning openings of the telescoping tubes.

6. A method of locking a first pipe end to a second pipe end together comprising:
providing a hydraulic hose clamp comprising:
an elongated body comprising a first end and a second end;
a first U-shaped plate pivotable coupled to the first end and extending downwards from the elongated body;
a handle fixedly coupled to the first U-shaped plate;
a second U-shaped plate coupled to the second end and extending downwards from the elongated body;
placing the first U-shaped plate around the first pipe and the second U-shaped plate around the second pipe; and
applying pressure to the handle, thereby pivoting the first U-shaped plate inwards and pushing the first pipe end towards the second pipe end.

7. The method of claim 6, wherein a length of the elongated body is adjustable.

8. The method of claim 7, wherein the elongated body comprises telescoping tubes, wherein one of the telescoping tubes comprises at least one opening, and the other of the telescoping tubes comprises a plurality of openings, wherein a lock pin fits within aligning openings of the telescoping tubes.
